(19) United States
(12) Patent Application Publication
(10) Pub. No.: US 2002/0134749 A1
(43) Pub. Date: Sep. 26, 2002

(54) Method of making a vertical, mirror quality surface in silicon and mirror made by the method

(75) Inventor: Dong-il Cho, Seoul (KR)

Correspondence Address: HOGAN & HARTSON L.L.P., 500 S. GRAND AVENUE, SUITE 1900, LOS ANGELES, CA, 90071-2611, US

(73) Assignee: Chromux Technologies. Inc.

(21) Appl. No.: 09/771,170

(22) Filed: Jan. 26, 2001

(51) Int. Cl. B29D 11/00

(52) U.S. Cl. 216/24

(57) ABSTRACT

A true vertical mirror is made in silicon along a vertical crystal plane of silicon. The method of making the mirror includes forming a mask on a (110) silicon surface so at least a portion of the mask is substantially aligned along an intersection between the (110) surface plane and a vertically extending (111) silicon plane. The mask is a layer of silicon oxide to facilitate a deep etching process. Vertical etching proceeds from the (110) surface substantially along the vertically extending (111) plane to form a first surface extending away from the (110) surface of the silicon. Lateral etching of the first surface creates a mirror-quality surface parallel to a vertically extending (111) crystalline plane. Advantageously, the lateral etching can be performed using an alkaline solution that tends not to etch the (111) face of silicon.

### BACKGROUND OF THE INVENTION

1. Field of the Invention

The present invention relates to integrated optical components and, in particular, to optical components that include a mirror for reflecting or directing an optical signal.

2. Description of the Related Art

Optical communications networks have become prevalent for long distance communications, including for the backbone of the Internet. Demand for additional bandwidth in optical networks continues to grow and a variety of different strategies have been adopted to improve the utilization of the bandwidth within existing optical fiber networks. For example, many high bandwidth networks multiplex signals on different wavelengths of light to create multiple channels for communication and make more efficient use of the available bandwidth. Multiple channel optical networks require a variety of switches to be operable, including add drop switches and multiplexers. The lack of adequate, reliable and cost-effective switches has retarded the implementation of optical networks and has limited switched optical networks to very high traffic systems. One component that is desired for optical switches and for other optical components is a high quality mirror suitable for reflecting or directing an optical signal that can be integrated with other optical components.

Aspects of the present invention take advantage of micromechanical manufacturing technology to provide optical components. Micromechanical systems include devices such as gyroscopes and horizontal mirror arrays formed on the surface of semiconductor substrates. These very small mechanical devices are formed on the surfaces of semiconductor substrates using semiconductor fabrication technology, including photolithography, thin film deposition, etching, and impurity doping by diffusion and ion implantation. Micromechanical manufacturing techniques have been used in the past in attempts to manufacture vertical silicon surfaces. To date, adequate vertical mirrors have not resulted. These failures relate in part to the fact that etchants for semiconductors are not ideal—any etchant has a finite selectivity, rather than the infinite selectivity that would be required to create a vertical mirror extending perpendicular to a surface of a semiconductor substrate.

One example of the finite selectivity of etchants is discussed below with respect to FIGS. 1-4. This example is presented with reference to micromechanical manufacturing techniques applied to silicon substrates. Silicon processing almost always proceeds from a well-defined crystalline plane of a single crystal silicon wafer. Various crystalline planes of silicon are known to have families of crystalline planes extending perpendicularly from the facing crystalline plane. For example, silicon wafers can be obtained having a (110) face of silicon. FIG. 1 schematically shows such a wafer 10, with a flat 12 cut along a plane perpendicular to the <111> direction of silicon, as is conventional in the silicon wafer production art. FIG. 2 shows representative ones of the {111} family of planes extending perpendicularly from the (110) surface face of the silicon wafer 10. As shown, one of the {111} families 14 extends parallel to the flat 12 of the (110) wafer and another family 16 of {111} planes is arranged at an angle θ of 70.52° with respect to the first family 14 of {111} planes.

Alkaline solutions etch the (100) and (110) faces, and other faces, of silicon highly preferentially with respect to (111) faces of silicon. In other words, alkaline solutions readily etch silicon (100) and (110) faces of silicon while such alkaline solutions do not effectively etch (111) faces of silicon. At least theoretically, it would be possible to form a vertical mirror surface by using an alkaline solution to vertically etch from a (110) silicon surface vertically along {111} planes of silicon. This strategy does not work in practice because alkaline solutions have a finite selectivity of approximately 50:1 between etching (110) faces and (111) faces of silicon. The finite selectivity of an alkaline etchant for preferentially etching a (110) face of silicon and etching along a (111) plane of silicon is illustrated in FIG. 3. FIG. 3 shows an etched structure 18 formed by alkaline etching using a silicon oxide or silicon nitride mask 20 to define the extent of etch. The mask 20 has a nominal width of 50 μm. Alkaline etching proceeds to a depth of 500 μm (“h”) and slightly etches in the <111> direction while etching primarily in the <110> direction. As a result, the top of the structure 18 has a width of 30 μm while the base of the structure t₂ is about the original width of the mask, 50 μm, and the mask 20 is undercut along both sides of the structure 18.

FIG. 3 shows that the walls of the structure 18 are not vertical. Rather, the walls have a slope β=1.15° (inward) from vertical. Thus, while the surfaces of the walls are generally of high quality, the slope of the walls is too great to serve as a mirror for most communications applications. FIG. 4 shows a microphotograph of a structure manufactured in silicon by etching a (110) surface using a mask and an alkaline etchant. The slope of the walls of this structure, although only on the order of 1.15°, is quite apparent in FIG. 4. A mirror using this (111) face will misdirect a light beam by 2.3°.

A different strategy for vertically etching silicon uses reactive ion etching. Reactive ion etching is well known in the silicon art and can be performed in any number of commercial systems. FIG. 5 schematically shows a number of different reactive ion etching chambers using different technologies, including a capacitively coupled plasma (“CCP”) chamber, a magnetically enhanced reactive ion etch (“MERIE”) chamber, and an inductively coupled plasma (“ICP”) chamber. As is known in the art, reactive ion etching proceeds through a combination of etch mechanisms driven by a number of different forces. Aspects of these are illustrated in FIG. 6 and include the sputtering process that mechanically removes silicon through kinetic transfer. Chemical processes provide reactive substances to the silicon surface where chemical reactions occur and the volatile byproducts of the reaction are removed. Thermal forces primarily affect the illustrated chemical processes. Both kinetic and thermal forces drive the illustrated ion-enhanced chemical process. Generally, thermal processes tend to be less selective and kinetic processes tend to be much more selective in reactive ion etching. Finally, it is known to provide a reaction inhibitor on the walls of a silicon structure during etching, whether through a separate process or by ensuring deposition of non-reactive byproducts on the walls of the structure during the etching process. As illustrated in FIG. 6, the various reactive ion etching technologies have different levels of selectivity between vertical and lateral etching, and so produce vertical structures with varying degrees of success.

Substantially vertical walls can be formed in the illustrated reactive ion etching processes, but vertical mirror walls appropriate for optical communications have not been produced. Generally capacitively coupled plasma and inductively coupled plasma reactive ion etching produce more vertical walls for etched structures and MERIE produces angled walls. Different plasma chemistries are known and chlorine chemistries (derived from Cl₂ or BCl₃, for example) generally produce more vertical structures than fluorine chemistries (derived from, for example, SF₆). FIG. 7 shows a 40 μm deep structure etched into a silicon substrate using capacitively coupled plasma reactive ion etching with an etchant derived from a combination of Cl₂ and BCl₃ source gases. The walls of this structure are nearly vertical in that they have an angle on the order of 88° with respect to the surface plane of the silicon substrate.

It is also possible to form nearly vertical structures using other reactive ion etching processes including using SF₆ as a source gas. This is accomplished using a lowered etch pressure to increase the kinetic, ion-enhanced etching mechanism. FIG. 8 shows a structure formed using such a strategy that is 300 μm in height. The wall inclination is between about 86.0-88.0°. True vertical walls have not been achieved using this method.

Still another strategy has come into use for performing deep reactive ion etching, particularly in the manufacture of micromechanical structure. What is known as the Bosch process, developed by Robert Bosch GmbH of Germany, is an anisotropic, reactive ion etching process that is automated to produce substantially vertical structures over extended etching distances. Etching equipment that provides an automated implementation of the Bosch process is commercially available, for example, from Surface Technology Systems, Ltd. of Newport, Wales or Alcatel Thin Film Systems of Paris, France and other vendors. The automated Bosch process is illustrated in FIG. 9. SF₆ is used as the source gas in the commercially available implementations of the Bosch process.

First, as shown in FIG. 9(a), an etch mask 20 is formed on the silicon substrate 22 exposing the substrate where it is to be etched. Inductively coupled plasma etching using an SF₆ source gas proceeds through a first etching step, as illustrated in FIG. 9(b). Next, the automated equipment deposits a layer of polymer material 24 over the exposed surfaces. The polymer material acts as a passivation layer as it is not readily etched by the SF₆-derived etchant. An oxygen (O₂) plasma removes the polymer passivation layer 24 from the bottom of the etched portion of the substrate so that further etching leaves sidewall passivation layers 26 on the already etched portion of the trench. A further etching cycle etches deeper into the substrate producing the intermediate structure illustrated in FIG. 9(d). The steps illustrated in FIGS. 9(b)-9(d) are repeated to perform further etching cycles.

The Bosch process illustrated in FIG. 9 can produce silicon structures with substantially vertical walls. For example, it is possible to form walls that have an angle on the order of 88-90° with respect to the surface plane. The high level of verticality that can be achieved through the Bosch process is illustrated in FIG. 10. On the other hand, FIG. 10 also shows the characteristic scalloped edges produced by the Bosch process. Such surface irregularities produce unacceptable scatter and so make the illustrated structure unsuitable as a mirror.

Consequently, it is desirable to provide a more effective method for forming a vertical mirror.

### SUMMARY OF THE PREFERRED EMBODIMENTS

One aspect of the present invention provides a method of making an optical component including vertically etching a (110) face of silicon to form a first surface extending away from the (110) face of silicon. The method includes laterally etching the first surface to expose a (111) face of silicon.

Another aspect of the present invention makes an optical component by forming a mask over a (110) face of silicon so that at least a portion of the mask is substantially aligned along an intersection between the (110) face and a (111) face. The method includes vertically etching the (110) face to form a first surface extending away from the (110) face of silicon and laterally etching that first surface to expose a (111) face of silicon.

Still another aspect of the invention provides a method of making an optical component in which a mask is formed over a single crystal portion of a substrate. At least a portion of the mask is substantially aligned along an intersection between a surface plane of the substrate and a vertically extending crystalline plane in the substrate. The method includes vertically etching from the intersection along the vertically extending crystalline plane in the substrate to form a first surface extending away from the surface of the substrate. Laterally etching the first surface exposes a second surface extending substantially along the vertically extending crystalline plane in the substrate.

### BRIEF DESCRIPTION OF THE DRAWINGS

Aspects and various advantages of the present invention are described below, with reference to the various views of the drawings, which form a part of this disclosure.

FIG. 1 schematically illustrates a silicon wafer having a (110) face.

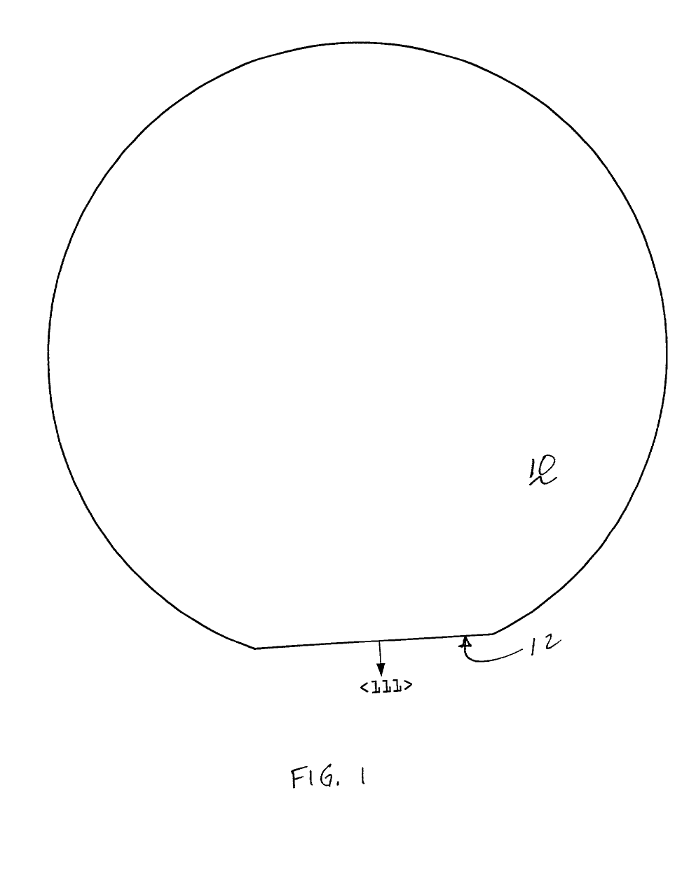

FIG. 2 schematically illustrates a silicon wafer having a (110) face and further indicating two families of {111} planes extending perpendicularly away from the (110) face of the silicon wafer.

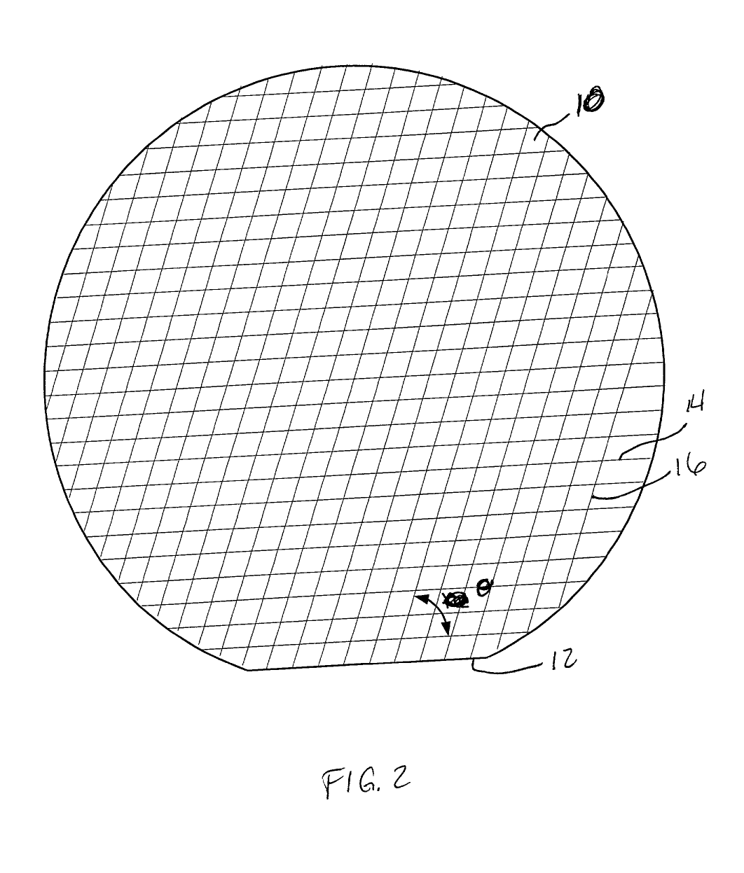

FIG. 3 schematically illustrates the effects of finite selectivity on a prolonged alkaline etch.

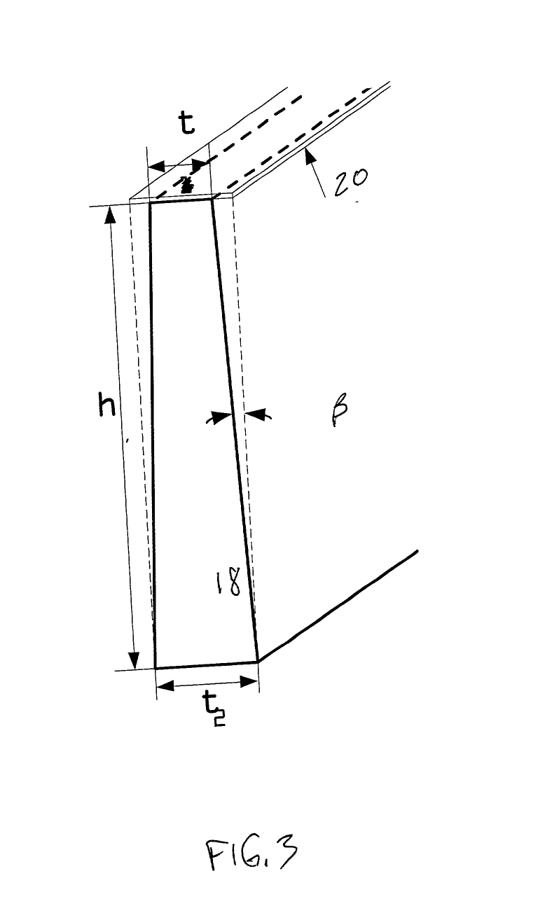

FIG. 4 provides a microphotograph of a silicon structure formed in the manner illustrated in FIG. 3.

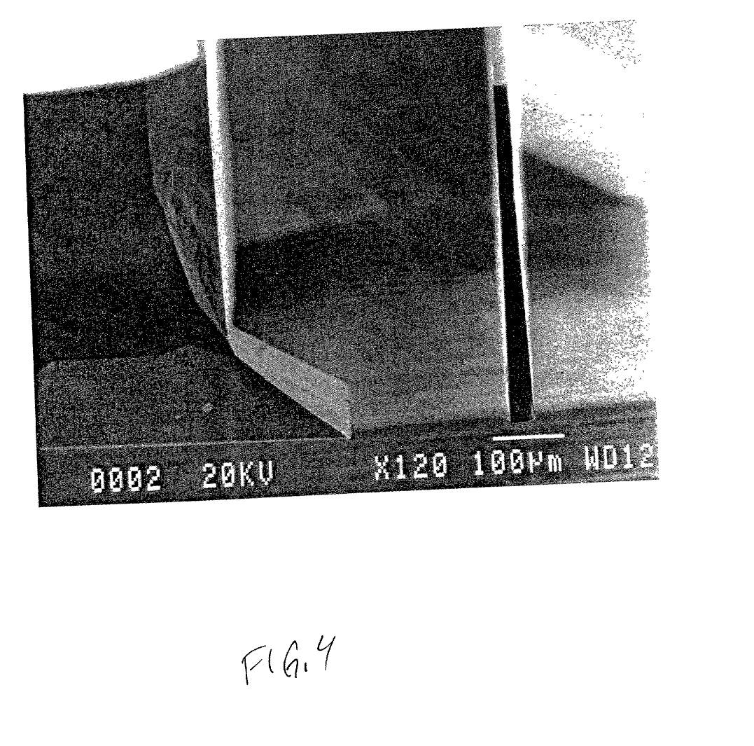

FIG. 5 illustrates generally various reactive ion etching chambers.

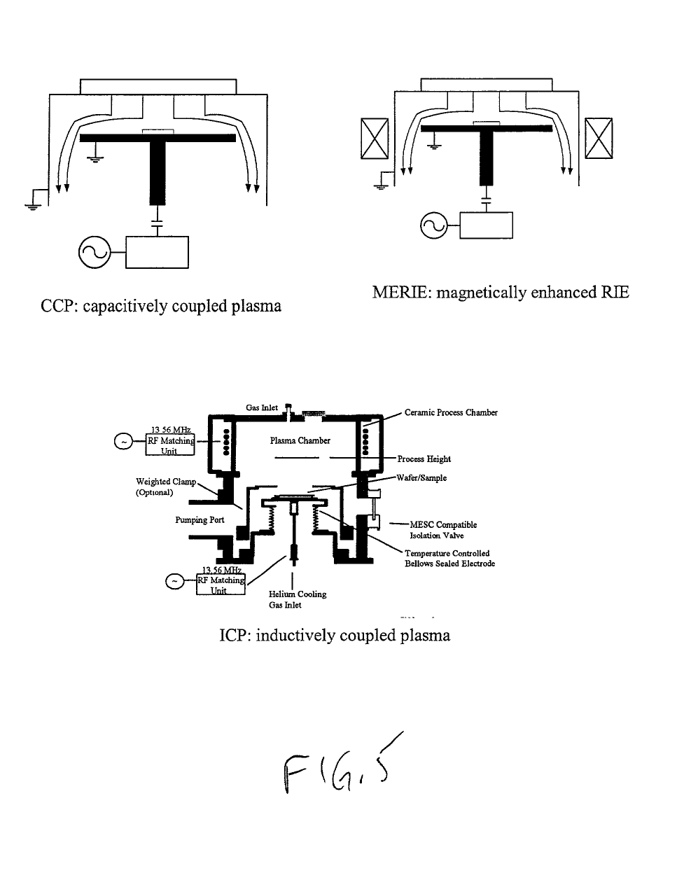

FIG. 6 illustrates schematically different etching mechanisms involved in reactive ion etching.

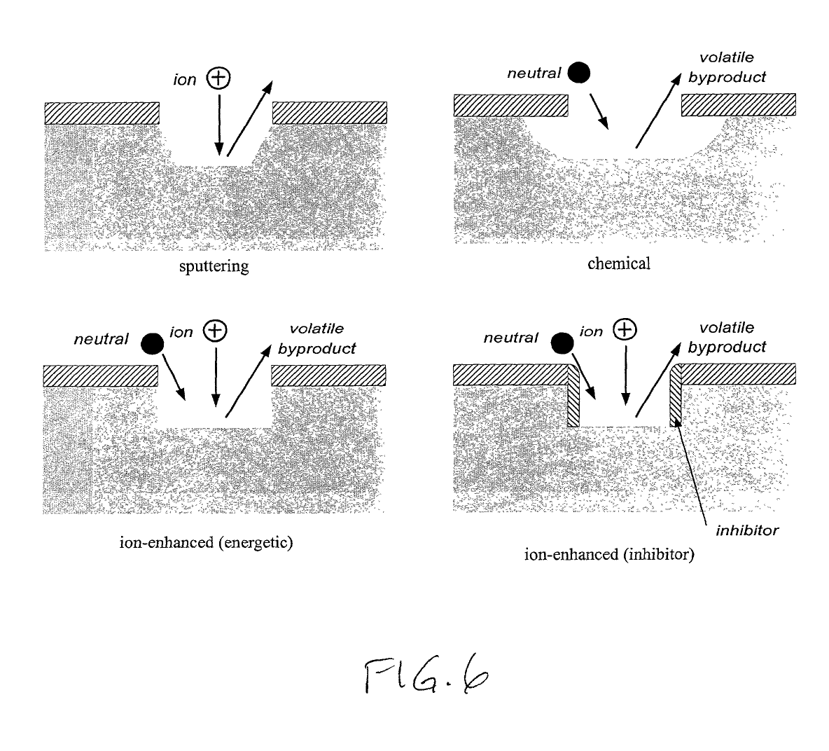

FIG. 7 illustrates a structure etched using capacitively coupled reactive ion etching with chlorine source gases.

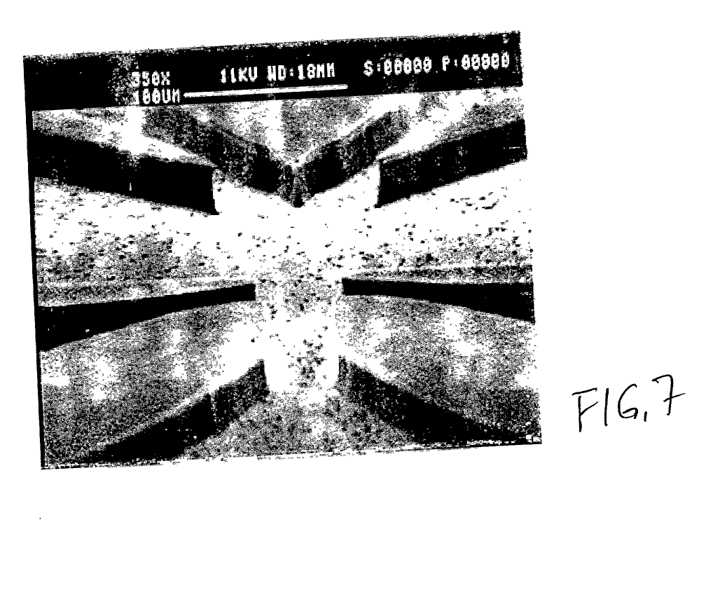

FIG. 8 illustrates a structure etched into a silicon substrate using a low pressure capacitively coupled plasma reactive ion etching process with an SF₆ source gas.

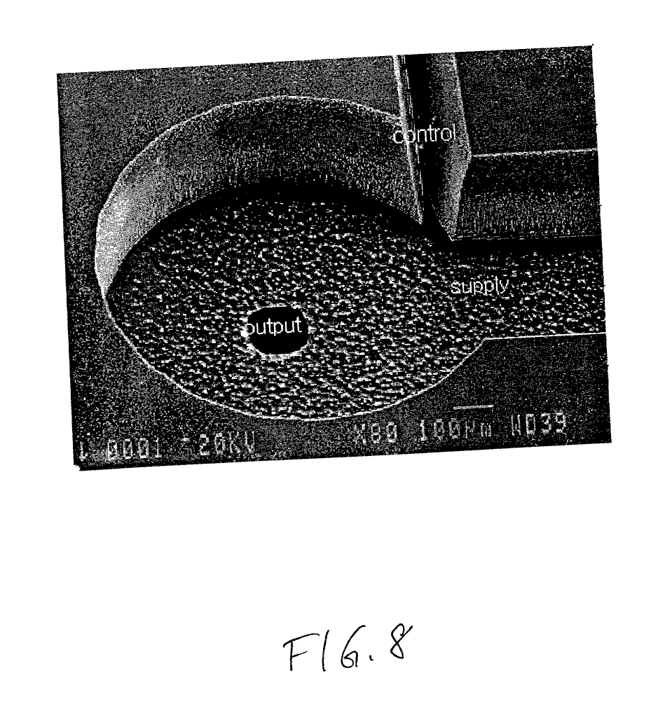

FIG. 9 schematically illustrates various stages of the Bosch process for deep reactive ion etching.

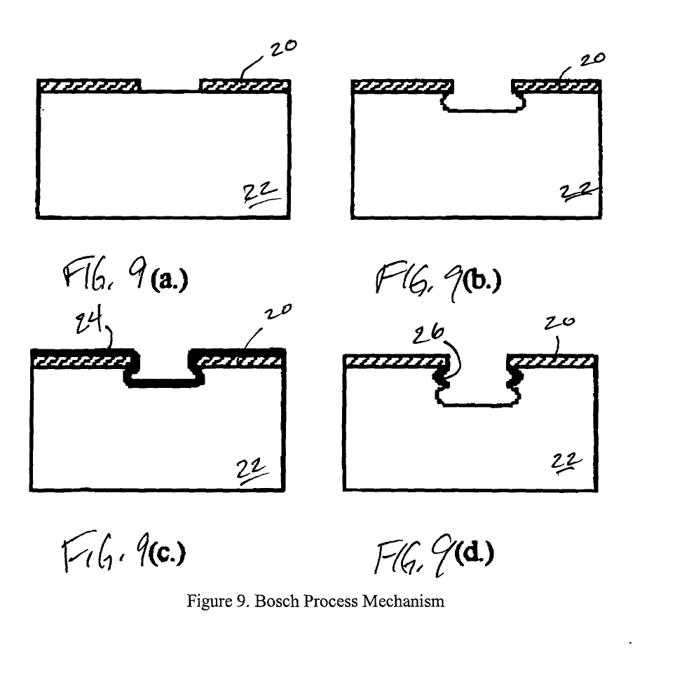

FIG. 10 is a microphotograph illustrating a structure manufactured using the Bosch process.

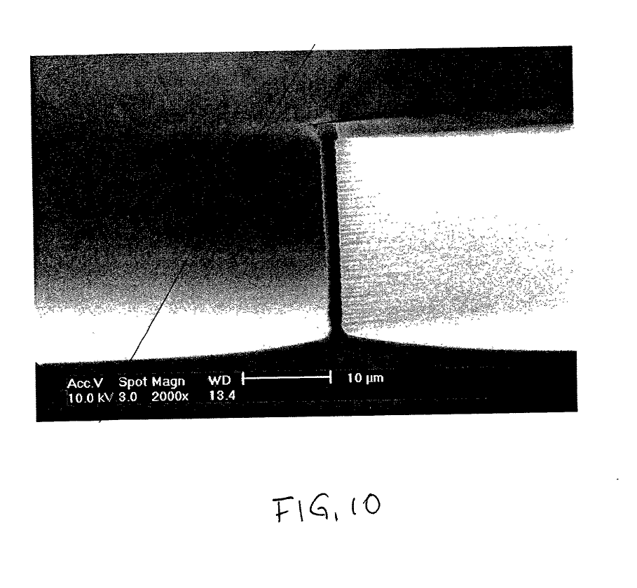

FIGS. 11-12 schematically illustrate process steps in accordance with a preferred embodiment of aspects of the present invention.

FIG. 13 schematically illustrates aspects of an etch geometry practiced in an implementation of the present invention using the Bosch process in a preliminary stage.

FIG. 14 is a microphotograph of a structure formed according to the process schematically illustrated in FIG. 11.

FIGS. 15-16 schematically illustrate further process steps in accordance with a preferred embodiment of aspects of the present invention.

FIGS. 17-20 are microphotographs illustrating structures manufactured in accordance with aspects of the present invention.

### DETAILED DESCRIPTION OF THE PREFERRED EMBODIMENTS

Preferred embodiments of the present invention provide a method of making a truly vertical mirror in a silicon substrate. This may be accomplished by taking advantage of the crystalline planes of silicon and the different surface bonds and chemical activities of different surfaces of silicon. In a particularly preferred implementation of the present invention, a first etch extends substantially vertically near a preferred crystalline plane in the silicon substrate. A second, preferential etch is made laterally with the etchant preferentially stopping on the preferred crystalline plane in the silicon substrate.

A true vertical mirror is made in silicon along a vertical crystalline plane of silicon. A particularly preferred method of making the mirror includes forming a mask on a (110) silicon surface so at least a portion of the mask is substantially aligned along an intersection between the (110) surface plane and a vertically extending (111) silicon plane. Preferably the mask is a layer of oxide to facilitate a deep etching process. Vertical etching proceeds from the (110) surface substantially along the vertically extending (111) plane to form a first surface extending down, away from the (110) surface of the silicon. The vertical etching is preferably a reactive ion etching process, for example, implementing the so-called Bosch process. In this implementation, the first surface has a scalloped appearance as is characteristic of the Bosch process. In other implementations, the first surface is more planar but is angled with respect to vertical, for example on the order of two degrees or more. Lateral etching is then performed using an alkaline solution that tends to stop on the (111) face of silicon, preferably removing the scalloped surface or other non-planar, non-vertical portions of the first surface.

What constitutes a mirror surface is defined to a large extent by the intended application. Optical communication systems often operate with near to mid infrared wavelengths of light, with the most common wavelength being near 1550 nanometers. An appropriate mirror for optical communications has a surface roughness of less than one fifth of the wavelength of a helium-neon laser, which is 633 nanometers. This is the de facto definition of mirror quality used in optical communications. For optical communications, an appropriate mirror surface has a roughness of less than about 100-120 nanometers. What constitutes vertical may also vary in different applications. Generally a vertical surface might be considered to be at or near an angle of 90° with respect to the surface plane. Variations from an angle of 90° on the order of the allowable surface roughness are, for many applications, acceptable for a vertical wall.

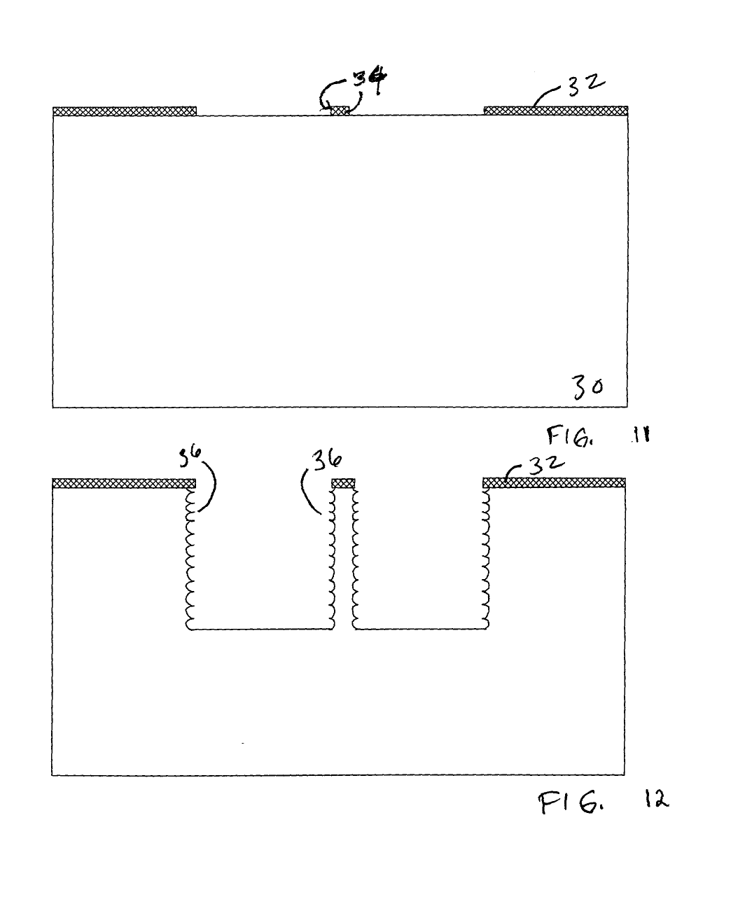

Particularly preferred embodiments of the present invention etch through a (110) surface of silicon and form a vertical mirror surface on or substantially on a (111) face of a silicon substrate 30, as shown in FIG. 11. The mirror definition process begins by providing a mask 32 on or above the preferred (110) surface of silicon. Edges of the mask 34 over the mirror structure are preferably aligned or substantially aligned parallel to the edges of {111} planes of the silicon substrate. The material and the thickness for the mask are preferably selected to accommodate a deep etching process. The mask might be made from silicon dioxide, silicon nitride or a combination thereof, might be deposited to a thickness on the order of 2000 Angstroms, and can be patterned using conventional photolithography. Next a deep etching process is performed to define the height of the mirror structure. The mirror might, for example, be formed on the order of 100-400 microns in height. The deep etching can be performed using a reactive ion etching process, for example using an inductively coupled plasma process. It is expected that such a deep etching process using reactive ion etching will produce an etched wall that is slanted by an angle of 1-3° from vertical. Greater angles are undesirable as it may not be possible to achieve a desired true vertical wall that is also desirably smooth.

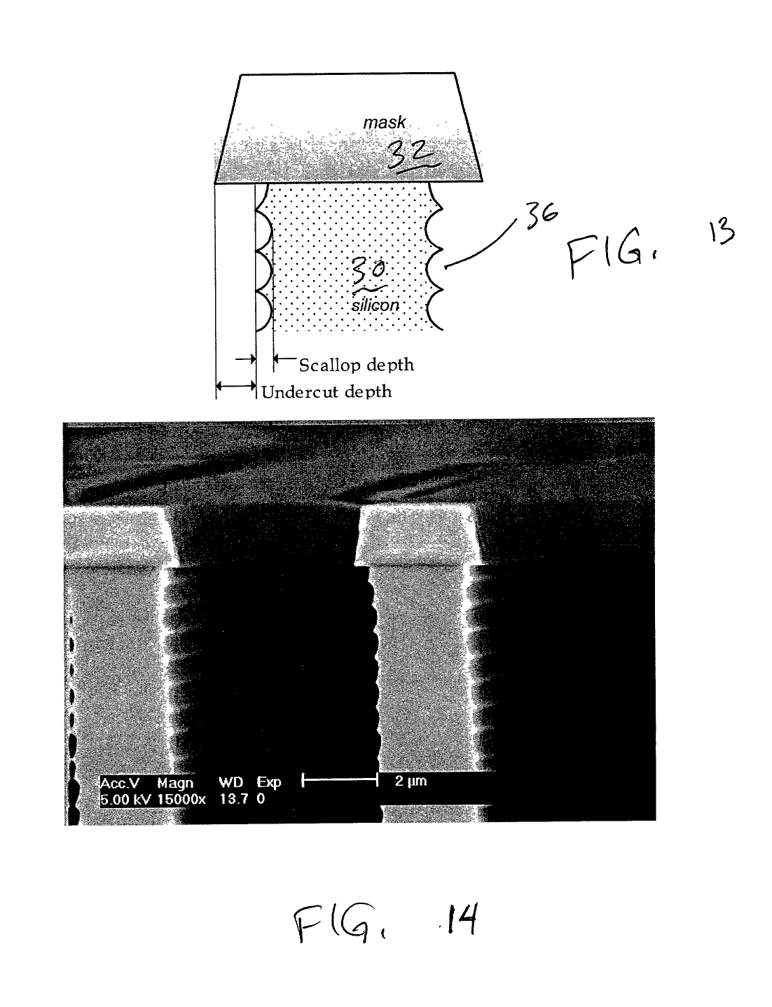

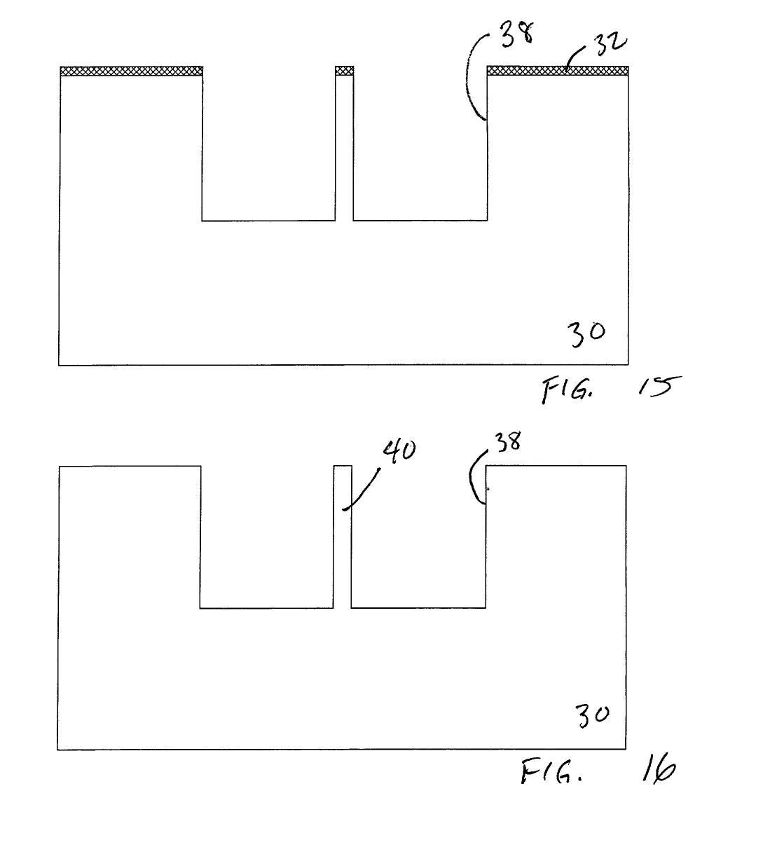

A presently more preferred process for the deep etch illustrated in FIG. 12 is the Bosch deep etching process. Inductively coupled plasma etching using an SF₆ source gas etches the silicon substrate through a first etching step, using the mask 32 to define the lateral extent of the deep etch. Next, the automated equipment deposits a layer of polymer material over the exposed surfaces. The polymer passivation layer is etched vertically in an oxygen (O₂) plasma to remove the polymer passivation layer 24 from the bottom of the etched portion of the substrate, leaving sidewall passivation layers on the etched portion of the trench. Further etching cycles are repeated automatically by the equipment to etch deeply into the substrate producing the structure illustrated in FIG. 12. The Bosch etching process produces scalloped sidewalls 36 as shown in FIG. 12 and as shown in greater detail in FIG. 13. FIG. 13 illustrates the depth of undercut and the scallop depth that need to be accommodated in aligning mask edges and designing the position of mirror surfaces. FIG. 14 shows a microphotograph including structures like those illustrated schematically in FIGS. 12 and 13.

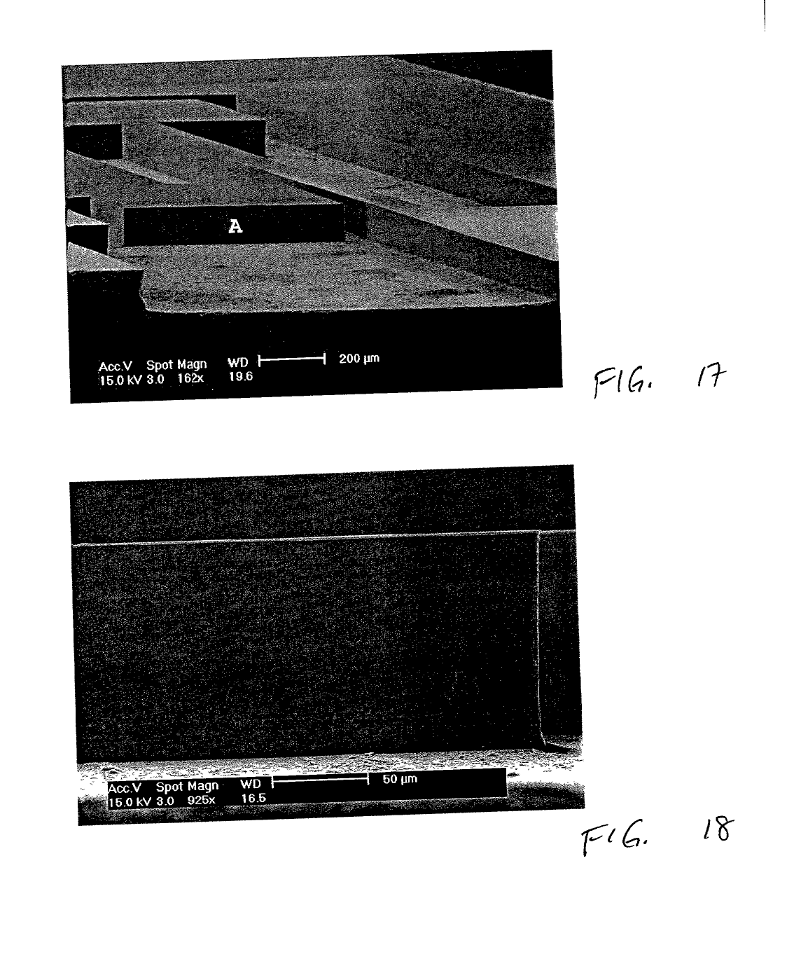

Whether achieved through deep reactive ion etching or through the illustrated Bosch process, the deep etched structure is next laterally etched, preferentially removing silicon from exposed faces such as (110) while substantially not etching the (111) face that extends substantially parallel to the deep etched walls. Various alkaline etching solutions may be used to preferentially etch the rough surfaces, including KOH, NaOH, ethylene diamine pyrocatechol (“EDP”) or tetramethyl ammonium hydroxide (“TMAH”). Two tables are presented below to illustrate the etching conditions that might be used in this process for laterally etching the rough surface. It is typically possible to produce the desired planarity and mirror qualities with an approximately one minute etch. This produces smooth walls 38 as illustrated in FIG. 15. The deep etch mask is then stripped, as shown in FIG. 16, for example using an HF strip in the case of a silicon oxide mask. This process produces mirror quality, vertical surfaces on the walls 38 of the substrate 30 and on the walls of the isolated structure 40 illustrated in FIG. 16.

TABLE 1
Silicon Etch Rates in KOH Solution

| Concent- | Tempera- | (100) | (110) | (111) | SiO₂ | | | |
|---|---|---|---|---|---|---|---|---|
| ration | ture | etch rate | etch rate | etch rate | etch rate | Other | (100)/ | (110)/ |
| [wt. %] | [° C.] | [μm/hr] | [μm/hr] | [μm/hr] | [μm/hr] | surfaces | (111) | (111) |
| 33 | 80 | 84 | — | — | 0.462 | — | — | — |
| 40 | 70 | | 67.59 | 1.455 | — | (311)53.08 | | 46.45 |
| | | | | | | (771)49.32 | | |
| 50 | 80 | | 93.35 | 1.174 | 0.250 | (311)63.33 | | 79.51 |
| | | | | | | (771)57.19 | | |
| 44 | 85 | 84 | | 0.21 | 0.084 | — | 400 | |
| 50 | 50 | 60 | | 0.15 | — | — | 400 | |
| 33 | 80 | 62.4 | — | — | — | (311)102 | — | — |
| 34 | 70.9 | 37.74 | 77.52 | 0.54 | — | — | 69.89 | 143.56 |
| 40 | 70 | — | 59.4 | — | — | — | — | — |
| 40 | 70 | | 55.8 | — | | — | — | — |
| 40 | 70 | — | 53.58 | — | — | — | — | — |
| 40 | 80 | — | 103.8 | — | — | — | — | — |
| 40 | 80 | | 99 | — | | — | — | — |
| 40 | 80 | — | 100.5 | — | — | — | — | — |
| 40 | 85 | — | 135.6 | — | — | — | — | — |
| 40 | 85 | — | 130.8 | — | — | — | — | — |
| 40 | 85 | — | 132 | — | — | — | — | — |
| 40 | 90 | | 171 | — | | — | — | — |
| 40 | 90 | — | 171 | — | — | — | — | — |

TABLE 2
Silicon Etch Rates in TMAH Solution

| | | (100) | (110) | (111) | SiO₂ | | | |
|---|---|---|---|---|---|---|---|---|
| Concent- | Tempera- | etch | etch | etch | etch | Si₃N₄ | | |
| ration | ture | rate | rate | rate | rate | etch rate | (100)/ | (110)/ |
| [wt. %] | [° C.] | [μm/hr] | [μm/hr] | [μm/hr] | [μm/hr] | (μm/hr) | (111) | (111) |
| 22 | 90 | 54 | 108 | 1.08 | | | 50 | 100 |
| 20 | 70 | 15 | | 0.7 | 0.0013 | 0.0001 | 21.43 | |
| 20 | 90 | 43 | | 1.4 | 0.008 | 0.0017 | 30.71 | |
| 25 | 80 | 23 | | 1.2 | 0.0025 | 0.0007 | 19.17 | |
| 15 | 80 | 32 | | 1.1 | 0.0045 | 0.0009 | 29.09 | |
| 20 | 79.8 | 36.18 | 66.84 | 1.02 | | | 35.47 | 65.53 |
| 25 | 70 | 16.32 | 31.92 | 0.54 | | | 30.22 | 59.11 |
| 10 | 80 | 38.4 | 22.68 | | | | 30.22 | 59.11 |

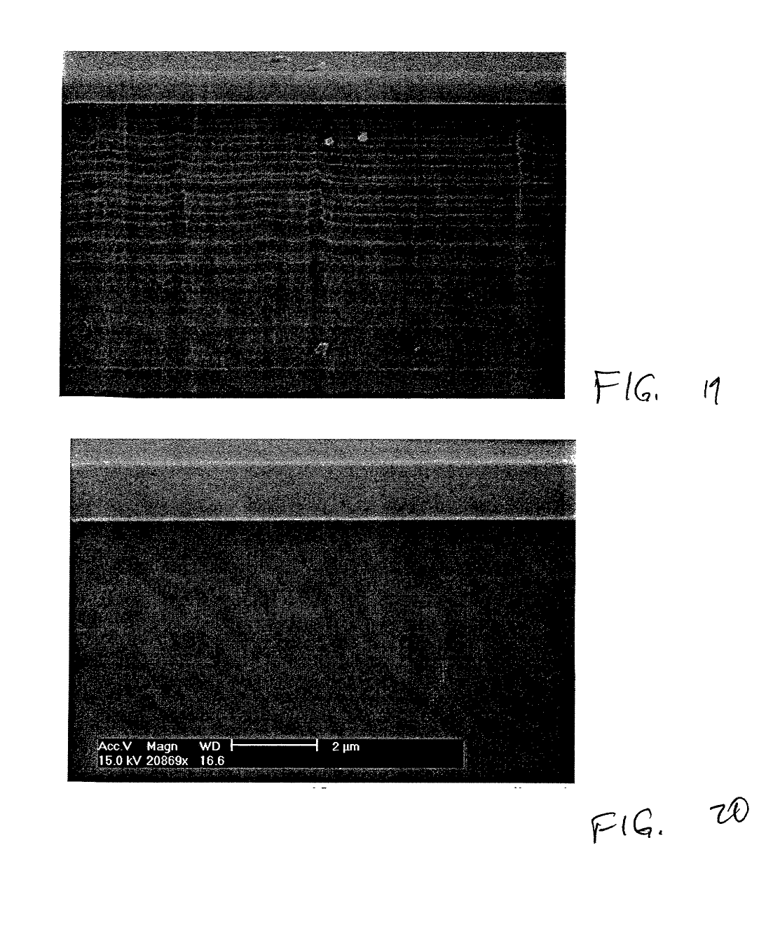

Aspects of an etching process like that discussed above are illustrated in the microphotographs of FIGS. 17-20. FIG. 17 shows the final, vertical mirror surfaces on walls of trenches (162×magnification). FIG. 18 shows the wall “A” identified in FIG. 17 at greater magnification (925×). FIG. 19 is a high magnification (˜8,000×) view of a surface after etching and before the mirrorizing alkaline etch and FIG. 20 shows the result of the mirrorizing alkaline etch (20,869×).

Following definition of a vertical surface of sufficient smoothness to function as a mirror, it is often desirable to provide a highly reflective surface for the vertical mirror-quality surface. When it is desirable to render the mirror-quality surface more reflective, the surface is preferably provided with a reflecting metallic coating. For example, the surface might be coated with a thin film of aluminum or gold, a layered structure including an inner layer of titanium and an outer reflective layer of gold, or a mixture of chromium and gold. These thin films are deposited in a sputtering, evaporation or other physical vapor deposition process. Such a thin metal film is preferred as being a cost-effective broadband reflector that is effective at various angles and at various wavelengths of light. An alternative to a thin metal film might, for example, be a multilayer dielectric stack, but such stacks are expensive to design and manufacture and typically have reduced effectiveness for light incident at an angle.

Although the present invention has been described in detail with reference only to the presently preferred embodiments, those of ordinary skill in the art will appreciate that various modifications can be made without departing from the invention. Accordingly, the invention is not to be limited to any of the described embodiments thereof but is instead defined by the following claims.

What is claimed:

1. A method of making an optical component, the method comprising:
vertically etching a (110) face of silicon to form a first surface extending away from the (110) face of silicon; and
laterally etching the first surface to expose a (111) face of silicon.

2. The method of claim 1, wherein the (111) face of silicon has a surface roughness of less than 100 nanometers.

3. The method of claim 1, wherein the vertically etching creates a scalloped surface.

4. The method of claim 3, wherein the vertically etching is a reactive ion etching process.

5. The method of claim 1, wherein the first surface is at an angle of approximately one degree or greater from vertical.

6. The method of claim 5, wherein the laterally etching is a reactive ion etching process.

7. The method of claim 1, wherein the laterally etching is a preferential etch.

8. The method of claim 7, wherein the laterally etching is an aqueous alkaline etch.

9. The method of claim 1, further comprising forming a mask over the (110) face before the vertical etching, at least a portion of the mask substantially aligned along an intersection between the (110) face and a (111) plane.

10. The method of claim 9, wherein the vertically etching creates a scalloped surface.

11. The method of claim 10, wherein the laterally etching is a preferential etch.

12. The method of claim 11, wherein the laterally etching is an aqueous alkaline etch.

13. The method of claim 12, wherein the (111) face of silicon has a surface roughness of less than 100 nanometers.

14. The method of claim 13, wherein the vertically etching creates a scalloped surface.

15. The method of claim 14, wherein the vertically etching is a reactive ion etching process.

16. The method of claim 12, wherein the first surface is at an angle of approximately one degree or greater from vertical.

17. The method of claim 16, wherein the laterally etching is a reactive ion etching process.

18. The method of claim 12, wherein the laterally etching has a duration of approximately two minutes or less.

19. A method of making an optical component, the method comprising:
forming a mask over a (110) face of silicon, at least a portion of the mask substantially aligned along an intersection between the (110) face and a (111) plane;
vertically etching the (110) face to form a first surface extending away from the (110) face of silicon; and
laterally etching the first surface to expose a (111) face of silicon.

20. The method of claim 19, wherein the mask includes an oxide layer.

21. The method of claim 19, wherein the vertically etching creates a scalloped surface.

22. The method of claim 19, wherein the laterally etching is a preferential etch.

23. The method of claim 22, wherein the laterally etching is an aqueous alkaline etch.

24. The method of claim 19, wherein the (111) face of silicon has a surface roughness of less than approximately 100 nanometers.

25. The method of claim 24, wherein the vertically etching creates a scalloped surface.

26. The method of claim 25, wherein the vertically etching is a reactive ion etching process.

27. The method of claim 26, wherein the first surface is at an angle of approximately two degrees or greater from vertical.

28. The method of claim 27, wherein the laterally etching is an aqueous alkaline etch.

29. The method of claim 28, wherein the laterally etching has a duration of approximately two minutes or less.

30. A method of making an optical component, the method comprising:
forming a mask over a single crystalline portion of a substrate, at least a portion of the mask substantially aligned along an intersection between a surface plane of the substrate and a vertically extending crystalline plane in the substrate;
vertically etching from the intersection along the vertically extending crystalline plane in the substrate to form a first surface extending away from the surface of the substrate; and
laterally etching the first surface to expose a second surface extending substantially along the vertically extending crystalline plane in the substrate.

31. The method of claim 30, wherein the laterally etching preferentially stops on the vertically extending crystalline plane in the substrate.

32. The method of claim 31, wherein the laterally etching is an alkaline aqueous etch.

34. The method of claim 30, wherein the second surface has a surface roughness of less than 100 nanometers.

35. The method of claim 34, wherein the substrate is silicon and the mask comprises an oxide layer.
